(19) United States
(12) Patent Application Publication
(10) Pub. No.: US 2025/0065955 A1
(43) Pub. Date: Feb. 27, 2025

(54) SIDE SILL STRUCTURE

(71) Applicant: HONDA MOTOR CO., LTD., Tokyo (JP)

(72) Inventors: Masahiro ITO, Wako-shi (JP); Takeyuki SUZUKI, Yokohama-shi (JP)

(21) Appl. No.: 18/809,553

(22) Filed: Aug. 20, 2024

(30) Foreign Application Priority Data
Aug. 22, 2023 (JP) 2023-134569

(51) Int. Cl. B62D 25/02; B62D 25/04; B62D 29/04

(52) U.S. Cl. CPC B62D 25/025; B62D 29/043; B62D 25/04

(57) ABSTRACT

A side sill structure includes a side sill extending in a front-rear direction of a vehicle on an outer side in a vehicle width direction of the vehicle, a plate member configured to divide at least a part of a cross-section of the side sill in the vehicle width direction, and a reinforcement made of plastic resin, the reinforcement being disposed outside the plate member in the vehicle width direction and bonded to the side sill. At least one of the reinforcement and the plate member has a plurality of projecting portions, and the other one of the reinforcement and the plate member has a plurality of receiving portions into which the projecting portions are inserted.

### CROSS-REFERENCE TO RELATED APPLICATION

This application claims the benefit of foreign priority to Japanese Patent Application No. 2023-134569, filed on Aug. 22, 2023, which is incorporated by reference in its entirety.

### TECHNICAL FIELD

The present invention relates to a side sill structure.

### BACKGROUND

In recent years, there has been a growing effort to provide access to sustainable transportation systems that take into account the vulnerable groups of transportation participants, such as the elderly, people with disabilities, and children. Toward this end, the inventors are focusing research and development efforts on further improving transportation safety and convenience through developments related to increasing vehicle rigidity.

As a conventional side sill structure, JP2010-143461A discloses a side sill structure including a plate member that divides the closed cross-section of the side sill in the vehicle width direction, and a pair of reinforcement members that are positioned in the closed cross-section of the side sill so as to sandwich the plate member from right and left sides in the vehicle width direction. Each of the reinforcement members of this side sill structure has a generally hat shape in cross-sectional view, and has a bulged portion bonded to the plate member and a flange portion bonded to an inner wall surface of the side sill. According to this side sill structure, the plate member and the reinforcement members ensure the rigidity of the side sill, allowing for a larger crash stroke of the side sill in the event of a side impact. Therefore, the side sill can efficiently absorb energy during the side impact.

However, in the conventional side sill structure disclosed in JP2010-143461A, since the bonded portion between each reinforcement member and the plate member is located in the hollow closed section of the side sill, it is difficult for heat that promotes the hardening of the adhesive to be transferred to the bonded portion. If the adhesive strength between the reinforcement member and the plate member is insufficient, the reinforcement member and the plate member may slip when a side impact load is applied. As a result, the conventional side sill structure may not demonstrate sufficient rigidity due to ineffective load transfer in the event of a side impact. In this side sill structure, an additional heating process may be carried out for the bonded portions between the reinforcement members and the plate member. However, this may create another problem that will complicate the manufacturing process of the side sill structure.

In view of the above, an object of the present invention is to provide a side sill structure, which can improve the rigidity of the side sill compared with conventional side sill structures by a simple design that does not require extra heating to join parts in the closed cross-section of the side sill. This, in turn, contributes to the development of sustainable transport systems.

### SUMMARY

To achieve the above object, one aspect of the present invention is to provide a side sill structure, which includes: a side sill extending in a front-rear direction of a vehicle on an outer side in a vehicle width direction of the vehicle; a plate member configured to divide at least a part of a cross-section of the side sill in the vehicle width direction; and a reinforcement made of plastic resin, the reinforcement being disposed outside the plate member in the vehicle width direction and bonded to the side sill, wherein at least one of the reinforcement and the plate member has a plurality of projecting portions, and the other one of the reinforcement and the plate member has a plurality of receiving portions into which the projecting portions are inserted.

### BRIEF DESCRIPTION OF THE DRAWINGS

The drawings described herein are for illustration purposes only and are not intended to limit the scope of the present invention in any way.

FIG. 1 is a partially enlarged perspective view of a vehicle having a side sill structure according to one embodiment of the present invention.

FIG. 2 is an exploded perspective view of the side sill structure according to this embodiment.

FIG. 3 is a cross-sectional view taken along the line III-III of FIG. 1.

FIG. 4 is a partially enlarged view of the IV portion of FIG. 3.

FIG. 5 is a cross-sectional view taken along the line V-V of FIG. 4.

FIG. 6 is a partially enlarged perspective view showing the arrangement of bulkheads in the side sill structure according to this embodiment.

FIG. 7 is a partially enlarged cross-sectional view showing a modification of the side sill structure.

### DETAILED DESCRIPTION

With reference to the drawing where necessary, one embodiment of a side sill structure according to the present invention will be described in detail. In the drawings, front and rear directions shown by arrows refer to corresponding front and rear directions in the longitudinal direction (i.e., front-rear direction) of a vehicle, upper and lower directions shown by arrows refer to corresponding upper and lower directions in the vertical direction (i.e., upper-lower direction) of the vehicle, and right and left directions shown by arrows refer to corresponding right and left directions in the vehicle width direction (i.e., lateral direction or right-left direction) of the vehicle. In the following description, the right-left direction of the vehicle may be referred to as the vehicle width direction.

The main feature of the side sill structure according to this embodiment is that a partition member (plate member) and a reinforcement member (reinforcement) made of plastic resin are joined together in a closed section of a side sill by fitting engagement.

The side sill structure is arranged in pairs corresponding to the pair of side sills arranged on the right and left sides of the vehicle. The pair of side sill structures has a symmetrical structure on both the right and left sides. In the following description, only the right side sill structure will be described, and a detailed description of the left side sill structure will be omitted.

First, the configuration of the vehicle is described prior to the explanation of the side sill structure.

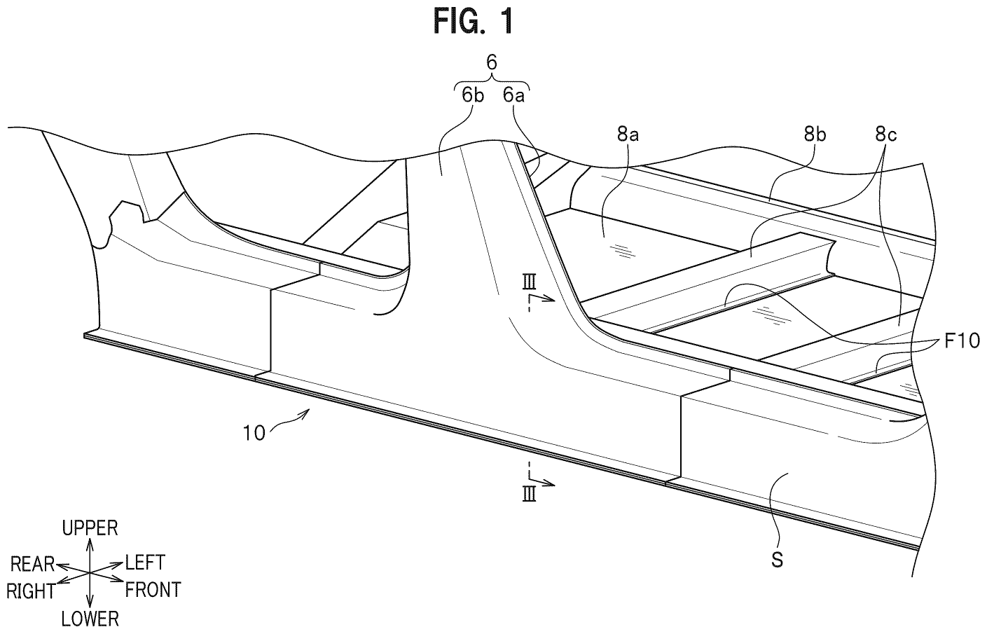

FIG. 1 is a partially enlarged perspective view of a vehicle having a side sill structure according to this embodiment.

As seen in FIG. 1, a side sill S, which constitutes a side sill structure 10, is a vehicle frame member located on a lower side part of the vehicle and extending in the front-rear direction of the vehicle.

A floor panel 8a is located between the right and left side sills S (the left side sill is omitted in FIG. 1). Outer edge portions of the floor panel 8a, which are located on the outer sides in the vehicle width direction, are joined by spot welding or other means to inner sides of the right and left side sills S in the vehicle width direction.

The floor panel 8a is integrally formed with a floor tunnel 8b, which is partially raised at the center in the vehicle width direction and extends in the front-rear direction.

Floor cross members 8c extending in the vehicle width direction are located on the floor panel 8a. When viewed in a cross-section intersecting with the extending direction of the floor cross member 8c, the floor cross member 8c has a hat shape that is open downward. A flange F10 of the floor cross member 8c corresponding to the brim of the hat-shape is joined by welding or other means to the floor panel 8a.

A lateral outer end portion of the floor cross member 8c is joined by welding to the inner side of the side sill S in the vehicle width direction. A lateral inner end portion of the floor cross member 8c is joined by welding to a side surface of the floor tunnel 8b.

In this embodiment, it is assumed that one pair of floor cross members 8c are arranged one behind the other on the floor panel 8a. However, the number of floor cross members 8c is not limited to this.

As seen in FIG. 1, a center pillar 6 is provided on the side sill S to extend upward from the side sill S.

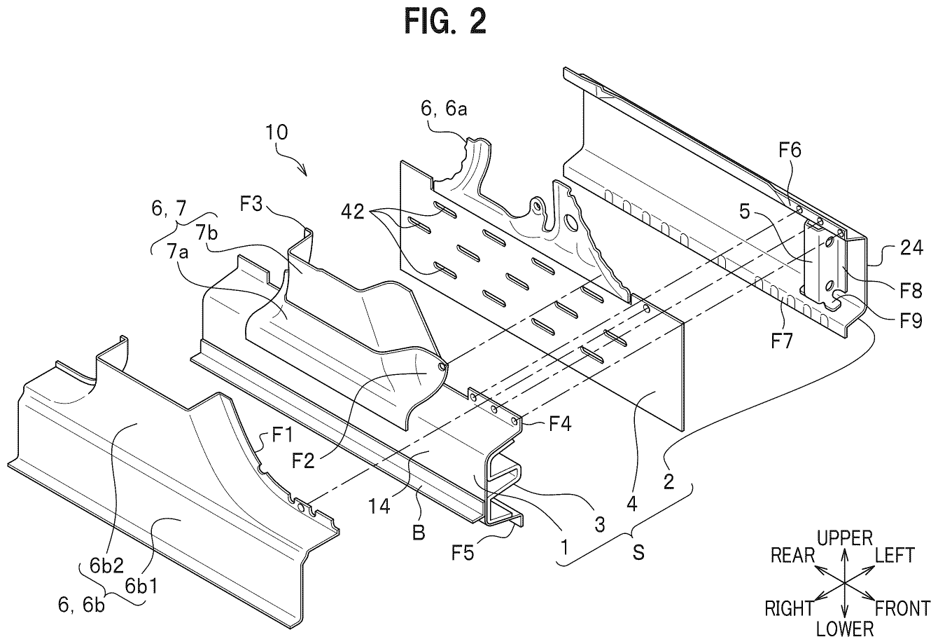

The center pillar 6 includes a pillar inner 6a located inside in the vehicle width direction, a pillar outer 6b located outside in the vehicle width direction, and a stiffener 7 (see FIG. 2) to be described later.

FIG. 2 is an exploded perspective view of the side sill structure 10.

As seen in FIG. 2, the pillar inner 6a is formed as a generally plate-like member whose width in the front-rear direction gradually increases from the top toward the bottom, thereby becoming wider.

Each of front and rear edges of the pillar inner 6a is formed to have a gentle curve that extends along the top surface of the side sill S (see FIG. 1) and is recessed downward as it approaches the side sill S.

Lower end portions of the pillar inner 6a in the front-rear direction are sandwiched between an upper flange F6 of a side sill inner 2 and an upper flange F4 of a side sill outer 1 to be described later, and joined together by spot welding or other means while stacking these three members. Further, the pillar inner 6a is joined by spot welding or other means to a flange F2 of the stiffener 7.

As seen in FIG. 2, the pillar outer 6b has a base portion 6b1 and a body portion 6b2. The base portion 6b1 has an L-shaped cross-section and is arranged to cover the lateral outer side of the side sill S. The body portion 6b2 extends upward from the base portion 6b1 to form a closed cross-section with the pillar inner 6a.

When viewed from side of the vehicle, the body portion 6b2 has a plan shape substantially the same as that of the pillar inner 6a.

Further, when viewed in a transverse cross-section, the body portion 6b2 has a hat shaped cross-section. The pillar outer 6b has a flange F1. The flange F1 of the pillar outer 6b is spot-welded or otherwise joined to the pillar inner 6a, with the pillar outer 6b superimposed on the pillar inner 6a, so that a closed cross-section is formed inside the center pillar 6.

The stiffener 7 is formed to correspond to the pillar outer 6b. The stiffener 7 is located in the closed section of the center pillar 6. A lower portion 7a of the stiffener 7 is spot-welded or otherwise joined over from top to side surfaces of the side sill outer 1 to be described later.

When viewed in a transverse cross-section, an upper portion 7b of the stiffener 7 has a hat shaped cross-section. The upper portion 7b of the stiffener 7 is spot-welded or otherwise joined to the lateral outer side surface of the pillar inner 6a at the flange F3.

Next, the side sill structure 10 according to this embodiment will be described.

As seen in FIG. 2, the side sill S, which constitutes the side sill structure 10, includes the side sill inner 2, the side sill outer 1, a plate member 4, a reinforcement 3, and bulkheads 5.

The side sill inner 2 is located inward (left side of FIG. 2) in the vehicle width direction, and when viewed in a cross-section intersecting with the longitudinal direction (front-rear direction in FIG. 2), the side sill inner 2 has a hat shape that opens outward in the vehicle width direction. To be more specific, the side sill inner 2 includes a bulged portion 24, an upper flange F6, and a lower flange F7.

The side sill outer 1 is located outward (right side of FIG. 2) of the side sill inner 2 in the vehicle width direction such that the plate member 4 is sandwiched between the side sill outer 1 and the side sill inner 2. When viewed in a cross-section intersecting with the longitudinal direction (front-rear direction in FIG. 2), the side sill outer 1 has a hat shape that opens inward in the vehicle width direction. To be more specific, the side sill outer 1 includes a bulged portion 14, an upper flange F4, and a lower flange F5. In FIG. 2, the reference numeral B indicates a bracket for attaching the base portion 6b1 of the pillar outer 6b to the side sill outer 1. This bracket B is a long member extending in the extension direction of the side sill S (front-rear direction in FIG. 2) and having an L-shaped cross-section. The bracket B is attached to the outer side surface of the side sill outer 1 by spot welding or other means.

The plate member 4 is formed of a long, flat plate that extends in the longitudinal direction of the side sill S (front-rear direction in FIG. 2) with its plate surface facing the vehicle width direction.

The plate member 4 is located directly below the center pillar 6 (pillar inner 6a).

The plate member 4 has a plurality of long round through-holes 42. Each through-hole 42 is long in the longitudinal direction (front-rear direction) of the plate member 4. To be more specific, three rows of long round through-holes 42 are arranged in a staggered pitch pattern in the upper-lower direction such that through-holes 42 in one row arranged at equal intervals in the front-rear direction are not directly above or below the through-holes in the adjacent row.

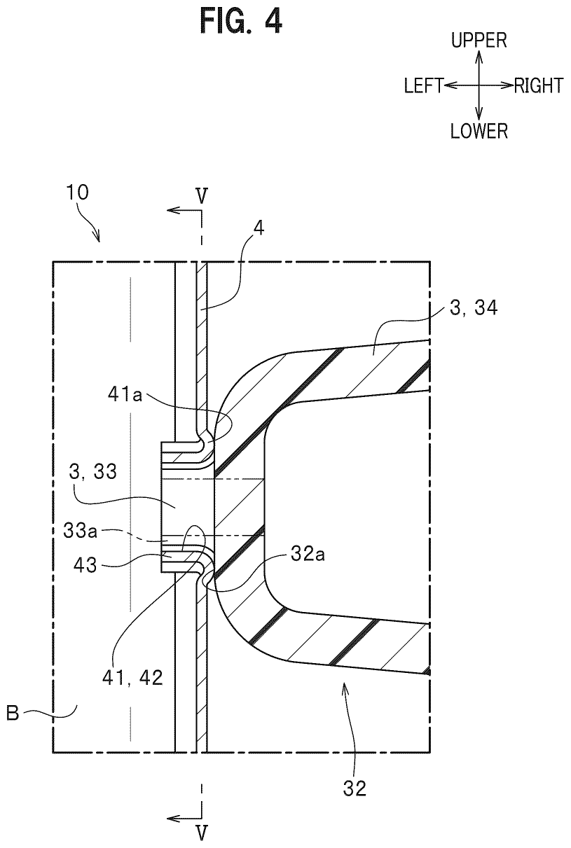

To be described later in detail, among these long round through-holes 42, the through-holes 42 arranged in the middle of the three rows are receiving portion 41 (see FIG. 4), into which the projecting portions 33 (see FIG. 4) of the reinforcement 3 are inserted.

The receiving portions 41, along with the reinforcement 3, are described in detail later.

The reinforcement 3 is a long member made of plastic resin and having a generally W-shaped cross-section extending in the extension direction of the side sill S (front-rear direction in FIG. 2). The reinforcement 3 is disposed inside the bulged portion 14 of the side sill outer 1.

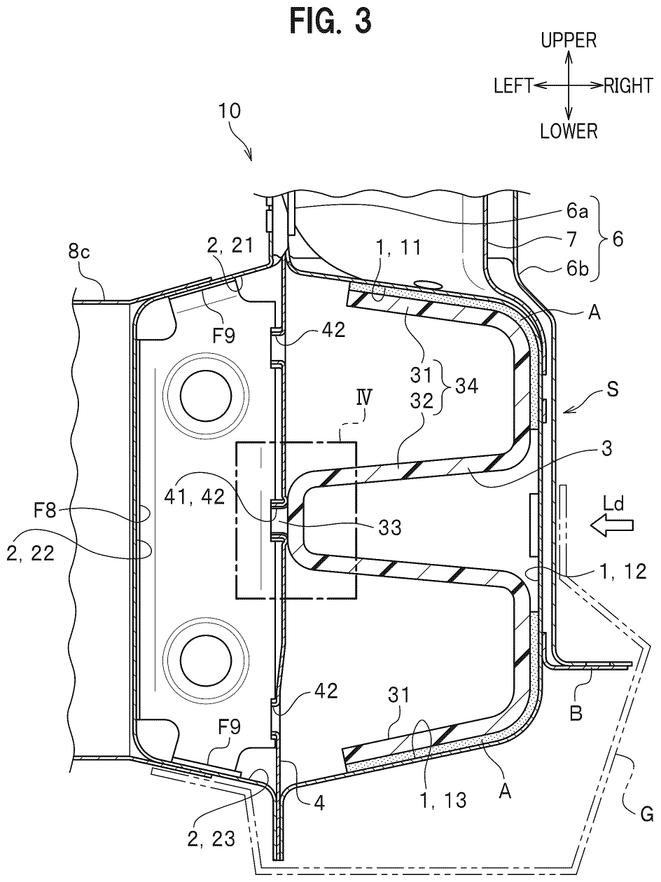

As seen in FIG. 3 that is a cross-sectional view taken along the line III-III of FIG. 1, the reinforcement 3 includes a pair of upper and lower outer protrusions 31 and an inner protrusion 32 located between the outer protrusions 31 and protruding toward the plate member 4.

The upper outer protrusion 31 is formed to closely contact an upper wall 11 and an outer wall 12 of the side sill outer 1 at a corner portion made between the upper wall 11 and the outer wall 12. The upper outer protrusion 31 is integrally joined to the side sill outer 1 with adhesive A in a region from the upper wall 11 to the outer wall 12.

The lower outer protrusion 31 is formed to closely contact a lower wall 13 and the outer wall 12 of the side sill outer 1 at a corner portion made between the lower wall 13 and the outer wall 12. The lower outer protrusion 31 is integrally joined to the side sill outer 1 with adhesive A in a region from the lower wall 13 to the outer wall 12.

It is assumed that the adhesive A according to this embodiment is a structural adhesive, such as an epoxy-based adhesive and a urethane-based adhesive. However, the adhesive A is not limited to these specific adhesives.

In FIG. 3, the reference numeral 6b indicates the pillar outer, the reference numeral 7 indicates the stiffener, and the reference numeral B indicates the bracket. The reference numeral G indicates a side sill garnish, which is omitted in FIGS. 1 and 2. The side sill garnish G, shown by a phantom line (two-dotted chain line), is a long plate-shaped member arranged to cover approximately the lower half of the side sill S in the longitudinal direction (direction perpendicular to FIG. 3) from laterally outer side in the vehicle width direction.

FIG. 4 is a partially enlarged view of the IV portion of FIG. 3.

As seen in FIG. 4, the projecting portions 33 are formed on the inner protrusion 32 of the reinforcement 3.

Each projecting portion 33 extends from an inner end portion 32a (as a base end) facing the plate surface of the plate member 4 toward the plate member 4. The projecting portions 33 are inserted into corresponding long round through-holes 42 of the plate member 4.

Detailed description will be given of the long round through-holes 42 formed in the plate member 4.

As seen in FIG. 3, the long round through-holes 42 serving as the receiving portions 41 of the plate member 4 into which the projecting portions 33 are inserted, are located in the middle row of the three rows of long round through-holes 42 arranged in the upper-lower direction. To be more specific, the plurality of receiving portions 41 are formed in the plate member 4 such that they are aligned in the front-rear direction (direction perpendicular to FIG. 3) at positions facing the inner protrusion 32 in the vehicle width direction.

As seen in FIG. 4, each of the receiving portions 41 of the plate member 4 has a tubular portion 43 extending inward in the vehicle width direction from the peripheral edge of the long round through-hole 42, which is the edge 41a of the receiving portion 41. The tubular portion 43 forms a collar portion into which the projecting portion 33 of the reinforcement 3 is fitted. The long round through-holes 42 and the tubular portions 43 in the receiving portions 41 are formed simultaneously by burring the plate member 4 made of a steel plate.

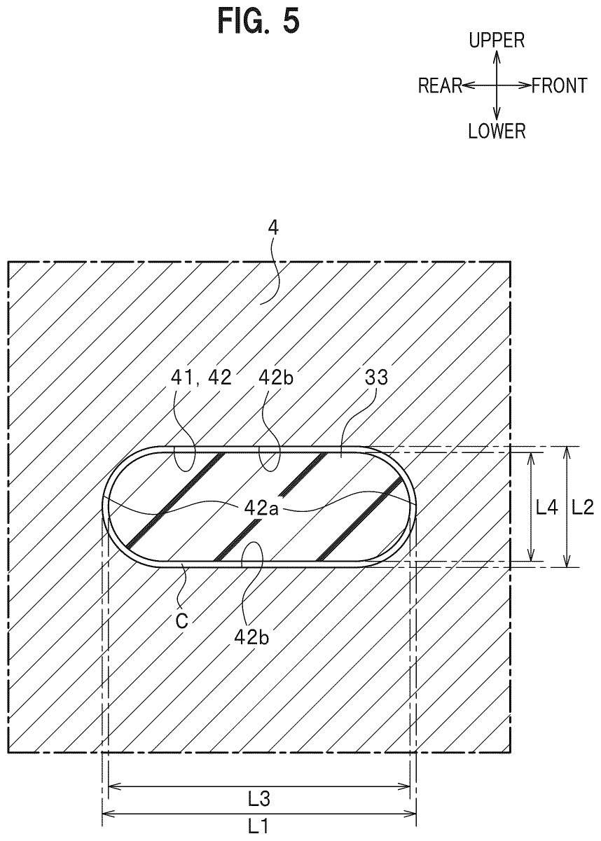

FIG. 5 is a cross-sectional view taken along the line V-V of FIG. 4.

As seen in FIG. 5, the long round through-hole 42, which is the receiving portion 41 of the plate member 4, has a length L1 in the longitudinal direction (front-rear direction) of the side sill S (see FIG. 1) that is longer than a length L2 in the upper-lower direction orthogonal to the longitudinal direction. To be more specific, the long round through-hole 42 has a generally track-shaped inner peripheral edge including a pair of front and rear circular arc portions 42a, and a pair of upper and lower straight portions 42b parallel to each other.

On the other hand, as seen in FIG. 5, the projecting portion 33 of the reinforcement 3, which is inserted into the receiving portion 41, has a generally track-shaped external shape that fits into the long round through-hole 42. In other words, the external shape of the projecting portion is formed such that its length L3 in the longitudinal direction (front-rear direction) of the side sill S is longer than its length L4 in the upper-lower direction orthogonal to the longitudinal direction.

The long round through-hole 42 and the projecting portion 33 have relationships of L1>L3 and L2>L4, and there is a slight clearance C between the long round through-hole 42 and the projecting portion 33. Although not shown in the drawings, these clearances C may be formed such that the long round through-holes 42 and the projecting portions 33 are at least partly spaced apart from each other.

The projecting portions 33 (see FIG. 4) according to this embodiment are assumed to be formed of solid members to be fitted into the tubular portions 43 of the receiving portions 41. However, as shown by the phantom line (double-dotted line) in FIG. 4, each of the projecting portions 33 may also be formed as a tubular member 33a.

The reinforcement 3 as described above is made of plastic resin. To be more specific, a reinforcement body 34 of the reinforcement 3, which has a generally W-shaped cross-section, is formed of fiber-reinforced resin, and the projecting portions 33 are formed of fiber-free resin. The reinforcement 3 can be manufactured by a known molding method such as RTM (Resin Transfer Molding) method.

As seen in FIG. 2, the bulkheads 5 are arranged inside the bulged portion 24 of the side sill inner 2, so that they are positioned inward of the plate member 4 in the vehicle width direction.

According to this embodiment, the bulkheads 5 have a hat shape that opens inward in the vehicle width direction (left side of FIG. 1) when viewed in a transverse cross-section.

As seen in FIG. 2, the bulkhead 5 includes flanges F8 formed at positions corresponding to the brim of the hat-shape, and flanges F9 formed at the upper and lower ends of the bulkhead (the upper flange is not shown in FIG. 2).

As seen in FIG. 3, the flanges F8 are joined to an inner wall 22 of the side sill inner 2 by spot welding or other means. The upper flange F9 is joined to an upper wall 21 of the side sill inner 2 by spot welding or other means. The lower flange F9 is joined to a lower wall 23 of the side sill inner 2 by spot welding or other means.

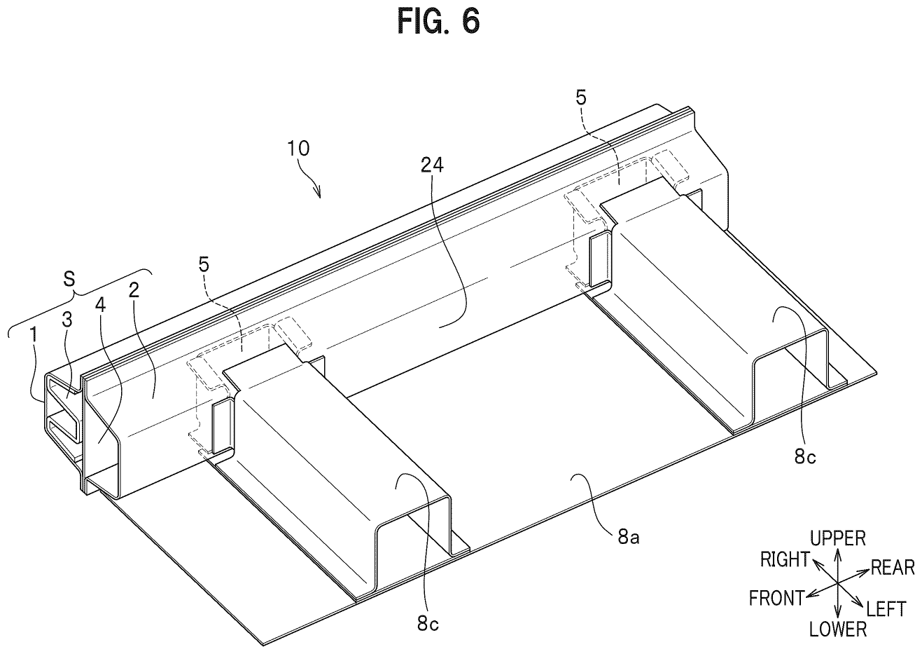

FIG. 6 is a partially enlarged perspective view showing the arrangement of bulkheads 5. FIG. 6 is a perspective view looking down on the side sill S from the inside of the vehicle. For drawing convenience, the center pillar 6 (see FIG. 1) is omitted in FIG. 6. Further, the bulkheads 5 are illustrated with hidden lines (dotted lines) in FIG. 6.

As seen in FIG. 6, the bulkheads 5 in this embodiment are arranged spaced apart from each other in the longitudinal direction (front-rear direction) of the side sill S, at positions corresponding to the pair of floor cross members 8c. The bulkhead 5 is formed to have substantially the same width as the front-rear width of the floor cross member 8c. In other words, the bulkheads 5 are located within the bulged portion 24 of the side sill inner 2 at positions where they are aligned in the front-rear direction with the joint portions of the floor cross member 8c and the side sill inner 2.

According to the side sill structure 10 described above, as seen in FIG. 3, a side collision load Ld applied to side sill outer 1 is efficiently transferred to the pair of upper and lower outer protrusions 31 of the reinforcement 3, the inner protrusion 32 of the reinforcement 3, the plate member 4, the bulkheads 5, the side sill inner 2, and the floor cross member 8c.

### Operation and Advantageous Effects

In the following description, a more specific explanation of the operation and advantageous effects of the side sill structure 10 according to this embodiment will be given.

The side sill structure 10 according to this embodiment is configured such that the reinforcement 3 has a plurality of projecting portions 33 and the plate member 4 has a plurality of receiving portions 41 into which the projecting portions 33 are inserted.

With this configuration of the side sill structure 10, slippage between the reinforcement 3 and the plate member 4 can be prevented when a side collision load is applied. The side collision load is more reliably transferred from the reinforcement 3 to the plate member 4. This allows the side sill structure 10 to achieve both increased rigidity and reduced deformation of the side sill S.

Further, since the side sill structure 10 is configured such that the reinforcement 3 and the plate member 4 are joined together by fitting engagement, the heating process for hardening adhesive, which is required for the conventional side sill structures (see, for example, JP2010-143461A), can be omitted. This can simplify the manufacturing process.

According to this embodiment, it is possible to provide the side sill structure 10, which can improve the rigidity of the side sill S compared with conventional side sill structures by a simple design that does not require extra heating to join parts in the closed cross-section of the side sill S.

Further, the side sill structure 10 is configured such that the reinforcement 3 is bonded through its outer protrusions 31 to three surfaces of the side sill outer 1, including the outer wall, the upper wall, and the lower wall of the side sill outer 1, and the reinforcement 3 is fitted into the plate member 4 through its inner protrusion 32.

With this configuration of the side sill structure 10, a side collision load is more effectively transferred from the reinforcement 3 to the plate member 4. The rigidity and deformation control performance of the side sill S can be further improved.

Further, the side sill structure 10 is configured such that the receiving portions 41 of the plate member 4 are formed by tubular portions 43 into which the projecting portions 33 of the reinforcement 3 are fitted.

With this configuration of the side sill structure 10, the contact area between the projecting portions 33 and the receiving portions 41 can be increased, ensuring that the fitting engagement between the reinforcement 3 and the plate member 4 is maintained more reliably when the side collision load is transferred from the reinforcement 3 to the plate member 4. This allows the side collision load to be more reliably transferred from the reinforcement 3 to the plate member 4.

Further, the side sill structure 10 is configured such that the projecting portions 33 are solid.

With this configuration of the side sill structure 10, deformation of the projecting portions 33 can be effectively suppressed when a side collision load is applied, and the rigidity of the side sill S can be further improved.

As an alternative, the side sill structure 10 is configured such that the projecting portions 33 are formed of tubular members 33a (see FIG. 4).

With this configuration of the side sill structure 10, since the projecting portions 33 are hollow, the weight of the side sill structure 10 can be reduced while maintaining the contact area between the projecting portions 33 and the receiving portions 41.

Further, with this configuration of the side sill structure 10, the space formed between the reinforcement 3 and the side sill outer 1 and the space formed between the plate member 4 and the side sill inner 2 can be connected through the tubular members 33a.

Further, the side sill structure 10 is configured such that the reinforcement body 34 of the reinforcement 3, which includes the outer protrusions 31 and the inner protrusion 32, is formed of fiber-reinforced resin and the projecting portions 33 are formed of fiber-free resin.

If both of the reinforcement body 34 and the projecting portions 33 of the reinforcement 3 are formed of fiber-reinforced resin, the orientation of reinforcing fibers in the reinforcement body 34 is disrupted in the vicinity of the projecting portions 33 due to the reinforcing fibers continuously extending from the reinforcement body 34 to the projecting portions 33. This may reduce the rigidity of the reinforcement body 34.

In contrast, since the projecting portions 33 in this embodiment are formed of fiber-free resin, the orientation of the reinforcing fibers in the reinforcement body 34 is not disrupted.

With this configuration of the side sill structure 10, the fitting engagement between the reinforcement 3 and the plate member 4 is carried out while ensuring sufficient rigidity of the reinforcement 3.

Further, the side sill structure 10 is configured such that the projecting portions 33 and the long round through-holes 42 (long holes) as the receiving portions 41 are long in the longitudinal direction (front-rear direction) of the side sill S. Further, the side sill structure 10 has a clearance such that the projecting portions 33 and the long round through-holes 42 (long holes) are at least partly spaced apart from each other.

With this configuration of the side sill structure 10, the moment generated in the side sill S during side collision causes the projecting portions 33 and the inner peripheral portions of the long round through-holes 42 (long holes) in the receiving portions 41 to contact each other in the upper-lower direction of the vehicle.

In this case, since the side sill structure 10 according to this embodiment is configured such that the projecting portions 33 and the long round through-holes 42 are long in the longitudinal direction (front-rear direction) of the side sill S, the contact area between the projecting portions 33 and the long round through-holes 42 can be increased. This reliably prevents slippage between the reinforcement 3 and the plate member 4.

Further, with this configuration of the side sill structure 10, when the projecting portions 33 of the reinforcement 3 are inserted into the long round through-holes 42 (long holes) of the plate member 4, variations in the mutual position of the long round through-holes 42 (long holes) and the projecting portions 33 in the longitudinal direction can be absorbed. According to this side sill structure 10, the fitting engagement between the long round through-holes 42 (long holes) and the projecting portions 33 can be carried out more reliably.

The long round through holes 42 (long holes) formed in the plate member 4 also serves as paths for electrodeposition coating liquid used during electrodeposition coating on the vehicle body. According to this side sill structure 10, electrodeposition coating can be applied evenly to the closed cross-section of the side sill S.

The plate member 4 of this side sill structure 10 is disposed directly below the center pillar 6 (pillar inner 6a).

With this configuration of the side sill structure 10, the side collision load received by the reinforcement 3 can be transferred to the center pillar 6 via the plate member 4. This can further improve the rigidity and deformation control performance of the side sill S.

Further, the side sill S of the side sill structure 10 includes a plurality of bulkheads 5 spaced apart from each other in the longitudinal direction (front-rear direction) of the side sill S, and the bulkheads 5 are arranged within the cross-section of the side sill S at positions inward of the plate member 4 in the vehicle width direction.

With this configuration of the side sill structure 10, since the bulkheads 5 are deformed by side collision load, energy can be more efficiently absorbed during the side collision.

Further, according to this side sill structure 10, the reinforcement 3 disposed outside the plate member 4 and the plurality of bulkheads 5 disposed inside the plate member 4 cooperate to each other during the side collision. This can efficiently distribute the side collision load.

One embodiment of the present invention has been described above. However, the present invention is not limited to the above specific embodiment but can be implemented in various forms.

According to the fitting structure in the above-described embodiment, the projecting portions 33 are formed on the reinforcement 3 and the receiving portions 41 for the projecting portions 33 are formed in the plate member 4. However, the fitting structure between the reinforcement 3 and the plate member 4 is not limited to this specific embodiment.

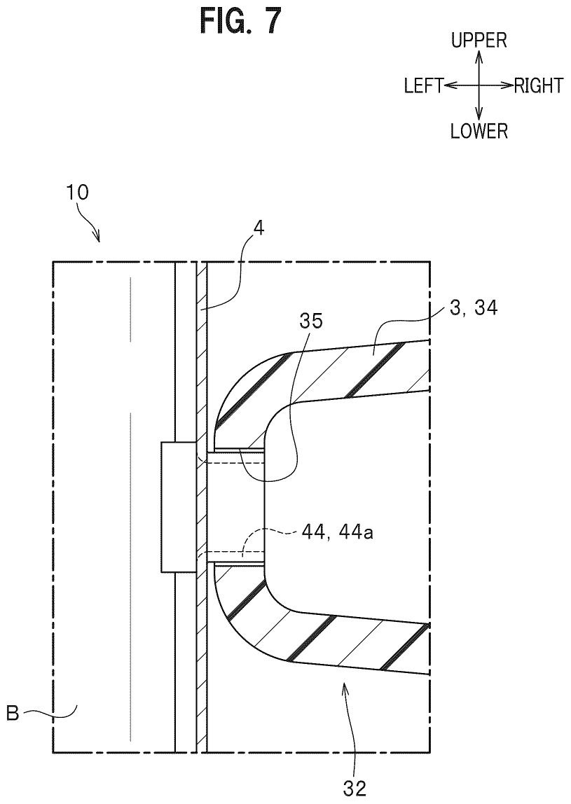

FIG. 7 is a partially enlarged cross-sectional view, corresponding to FIG. 4, showing a modification of the side sill structure 10 from the above-described embodiment.

As seen in FIG. 7, the side sill structure 10 according to this modification has tubular portions 44a, which serve as projecting portions 44, in the plate member 4. It is assumed that the tubular portions 44a are formed by burring the plate member 4.

On the other hand, receiving portions 35 are formed as through-holes in the inner protrusion 32 of the reinforcement 3, into which the tubular portions 44a are inserted.

With this configuration of the side sill structure 10, the structure of the reinforcement 3 can be simplified compared with the reinforcement 3 with the projecting portions 33 (see FIG. 4) described in the above embodiment. Further, according to this side sill structure 10, the projecting portions 44 of the plate member 4 are fitted into portions of the reinforcement 3, which are formed of fiber-reinforced resin. This can further improve the strength of the fitting structure.

It should be noted that the cross-sectional shape of the projecting portion 33 and the plan shape of the receiving portion 41 (hole) in the above embodiment are not limited, as long as they are long in the longitudinal direction (front-rear direction) of the side sill S; for example, they can have a longitudinal rectangular shape that is long in the front-rear direction.

Further, according to the above embodiment, each of the receiving portions 41 (see FIG. 4) includes a long round through-hole 42 (see FIG. 4) and a tubular portion 43 (see FIG. 4). However, the present invention is not limited to this specific configuration, and the receiving portion 41 may consist of only a long round through-hole 42, omitting the tubular portion 43.

What is claimed is:

1. A side sill structure comprising:
a side sill extending in a front-rear direction of a vehicle on an outer side in a vehicle width direction of the vehicle;
a plate member configured to divide at least a part of a cross-section of the side sill in the vehicle width direction; and
a reinforcement made of plastic resin, the reinforcement being disposed outside the plate member in the vehicle width direction and bonded to the side sill,
wherein at least one of the reinforcement and the plate member has a plurality of projecting portions, and the other one of the reinforcement and the plate member has a plurality of receiving portions into which the projecting portions are inserted.

2. The side sill structure according to claim 1, wherein
the reinforcement has outer protrusions joined to an outer wall, an upper wall, and a lower wall of the side sill with adhesive, and an inner protrusion protruding toward the plate member, and
the projecting portions or the receiving portions are formed at an inner end portion of the inner protrusion.

3. The side sill structure according to claim 2, wherein
the receiving portions are formed in the plate member to face the inner protrusion, and
the plate member has tubular portions extending in the vehicle width direction from edges of the receiving portions.

4. The side sill structure according to claim 3, wherein
the projecting portions are formed of solid members to be fitted into the tubular portions.

5. The side sill structure according to claim 3, wherein
the projecting portions are formed of tubular members to be fitted into the tubular portions.

6. The side sill structure according to claim 2, wherein
the outer protrusions and the inner protrusion of the reinforcement are formed of fiber-reinforced resin, and
the projecting portions are formed of fiber-free resin.

7. The side sill structure according to claim 1, wherein
each of the receiving portions is formed as a long hole whose length in a longitudinal direction of the side sill is longer than that in a direction orthogonal to the longitudinal direction,
an external shape of each of the projecting portions is formed such that a length thereof in the longitudinal direction of the side sill is longer than that in the direction orthogonal to the longitudinal direction, and
the projecting portions and the receiving portions are at least partly spaced apart from each other.

8. The side sill structure according to claim 1, wherein
the plate member is disposed directly below a pillar extending upward from the side sill.

9. The side sill structure according to claim 1, wherein
the side sill includes a plurality of bulkheads spaced apart from each other in a longitudinal direction of the side sill, the bulkheads being arranged within the cross-section of the side sill at positions inward of the plate member in the vehicle width direction.
